(19) United States
(12) Patent Application Publication
(10) Pub. No.: US 2007/0078800 A1
(43) Pub. Date: Apr. 5, 2007

(54) System and method of building an atomic view of a filesystem that lacks support for atomic operations

(76) Inventors: Robert Love, Cambridge, MA (US); Jon Eric Trowbridge, Chicago, IL (US)

Correspondence Address: PILLSBURY WINTHROP SHAW PITTMAN, LLP, P.O. BOX 10500, MCLEAN, VA, 22102, US

(21) Appl. No.: 11/240,447

(22) Filed: Oct. 3, 2005

(51) Int. Cl. G06F 17/30

(52) U.S. Cl. 707/1

(57) ABSTRACT

The invention is directed to a system and method of providing an accurate, consistent, and atomic view of a non-translational filesystem or a subset thereof, without explicit filesystem or file notification support for building an atomic view. A user-space algorithm is coupled with a file change notification kernel to identify changes to directories and objects within the directories in real-time so that the filesystem may remain atomically synchronized with any changes performed to the system, while avoiding a race hazard. When coupled with a file change notification system, the invention enables building of an atomic view of a filesystem in real-time, in user-space, and in memory.

### BACKGROUND

1. Field of the Invention

This invention relates to a system and method for providing an accurate, consistent, and atomic view of a non-transactional filesystem or a subset thereof. More particularly, the invention is directed to ensuring that a watch addition, which is inserted at a point in a directory of a filesystem, also adds a watch to all subdirectories and/or objects below the insertion point in the directory using a file change notification kernel and a user-space algorithm that identifies concurrent changes to the filesystem. Even more particularly, the invention is directed to maintaining an atomic view of a non-transactional filesystem in real-time.

2. Background Information

In computing, filesystems provide methods of storing and organizing computer files and corresponding data to simplify finding and accessing the computer files and the corresponding data. Filesystems may be used to organize and access data, whether the data is stored or is dynamically generated. For example, filesystems may use data storage devices, such as hard disks and/or CD-ROMs, to maintain a physical location of the files and to offer access to an array of fixed-size blocks, called sectors.

Filesystem software organizes these sectors into directories and files to keep track of which sectors belong to which file and which sectors are not being used. Directory structures may be flat or allow hierarchies, where directories may contain subdirectories. In UNIX-like filesystems, the directories typically associate file names with files by connecting the file name to an index, called an inode. inodes are data structures that are created when the filesystem is created. inodes provide information on files, such as user and group ownership, access mode (read, write, execute permissions) and type. Each file is assigned an inode and is identified by an inode number (i-number) in the filesystem where it resides. There are a set number of inodes, which indicates the maximum number of files the system can hold.

Modern filesystems generally are non-transactional, non-atomic or support only a few atomic operations (such as commands for open file or read file), inherently racey (include race hazards), and do not support transactions. Operations are considered atomic if they are either performed in their entirety or not performed at all. As a result of being non-atomic, when a view of the filesystem is generated, modern filesystems do not track changes to directories and/or files as they occur. Rather, during a time that a view of the filesystem is being captured and displayed, changes may be occurring to the directories and/or files (i.e., deletion, renaming, additions) that make the rendered view inaccurate. While file change notification systems currently exist, it is not possible to generate a consistent and complete view of the filesystem in real-time.

Known non-transactional filesystems use dnotify to track operations at the file descriptor using SIGIO. SIGIO is a signal that is sent when a file descriptor is ready to perform input or output. As a result, dnotify requires one file descriptor to be opened for each directory that is being watched. The file descriptor pins the directory, which disallows a backing device to be unmounted. This negatively affects removable media. Additionally, a per-process file descriptor limit may be reached when many directories are watched, thereby causing many open file descriptors to be open. dnotify is directory-based and only tracks changes to directories. While a change to a file in a directory affects the directory, the system must keep a cache of stat structures to compare files in order to determine which file in the directory was affected. dnotify's interface to user-space is not efficient because dnotify uses signals to communicate with user-space. Specifically, dnotify uses SIGIO or some other real-time signals to queue the events. However, dnotify remains deficient at least because it does not track changes to directories and/or files as they occur in real-time.

Other known non-transactional filesystems that are employed to build atomic views of the filesystem monitor file changes using a file change notification kernel that creates an inotify event, which is a record of a transaction that is stored in the kernel inotify queue. According to the known system, inotify uses a single file descriptor that is opened for the device node. Using the file descriptor at the device node eliminates pinning directories or opening a file descriptor for each directory. Usage includes opening the device, issuing simple commands via ioctl( ), and then blocking on the device. The kernel returns events when there are events to be returned. A user may select( ) on the device node to enable integration with main loops. While inotify may watch directories or files, inotify is deficient at least because it does not add a watch to all newly created subdirectories in real-time to monitor events that occur within subdirectories. Therefore, inotify may not capture all file system changes in real-time.

Other drawbacks exist with these and other known applications.

### SUMMARY

Various aspects of the invention overcome at least some of these and other drawbacks of known applications. According to one embodiment of the invention, an atomic view of a non-transactional filesystem is provided for data stored on a computer system using a file change notification system that is coupled with a user-space algorithm to identify changes to directories and objects in real-time. Any events that are generated when directories and/or objects are manipulated are tracked in real-time and may be used to update the atomic view. The invention also provides an algorithm that avoids a race hazard. A race hazard is a flaw in the process where the output exhibits unexpected and critical dependence on the relative timing of events. The user-space algorithm may recursively generate an accurate, consistent, and atomic view of the filesystem, or a subset thereof, from a given point in the filesystem without explicit filesystem or file notification system support for building the atomic view and while avoiding the race hazard associated with filesystems.

According to another embodiment of the invention, the user-space algorithm may be coupled with the known file change notification kernel (such as inotify) to create an inotify event. The directory traversal may be performed as either depth-first or breadth-first. Generally, if an event occurs on a watch signifying the creation of a new directory, but a watch has not yet been added to the new directory, then a watch is added to the new directory, a watch handler is set up, and any subdirectories are read. The algorithm avoids race hazards involving new directories by reading the contents of the directory after the watch is added.

According to another embodiment of the invention, a system is provided that includes at least one client terminal having a processor, a memory, a display and at least one input mechanism (e.g., keyboard or other input mechanism). The client terminal may be connected or connectable to other client terminals via wired, wireless, and/or a combination of wired and wireless connections and/or to servers via wired, wireless, and/or a combination of wired and wireless connections.

According to one embodiment of the invention, each client terminal accesses objects, including applications, documents, files, email messages, chat sessions, web sites, address book entries, calendar entries, web browsing history, RSS feeds, audio files, source code, instant message conversations, instant relay chat conversations, or other objects. The objects may include information, such as personal information, user data, and other information. Other applications may reside on the client terminal as desired.

Users may directly or indirectly access several types of objects during the course of the computer session. According to one embodiment of the invention, users may perform actions through a graphical user interface (GUI) or other interface. According to one embodiment of the invention, interactions with objects may be tracked using triggering events.

According to another embodiment of the invention, the client terminal may include a filesystem that manages the objects. Alternatively, the objects may be managed by a filesystem that is located at the server. The filesystem may include directories that associate object names with objects by connecting the object name to an index, called an inode. The object name associated with the gathered information may be indexed to keep track of the physical location of objects that are placed on a medium, the logical location of objects within a database, or other location of objects. The indexing may be performed in real-time to enable real-time searching of the filesystem. The client terminal and/or server may include a filesystem having other types of data.

According to one embodiment of the invention, the information corresponding to the objects may be displayed according to various configurations. For example, information corresponding to objects may be organized and displayed in a hierarchical order. In another embodiment of the invention, information corresponding to the objects may be displayed in a linear format, non-linear format or other format.

These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below. Where applicable, same features will be identified with the same reference numbers throughout the various drawings.

### BRIEF DESCRIPTION OF THE DRAWINGS

FIG. 1 illustrates an exemplary embodiment of a system diagram according to an embodiment of the invention.

FIG. 2 illustrates a B-tree according to one embodiment of the invention.

FIG. 3 illustrates a flow chart schematic for obtaining file change notifications according to one embodiment of the invention.

### DETAILED DESCRIPTION

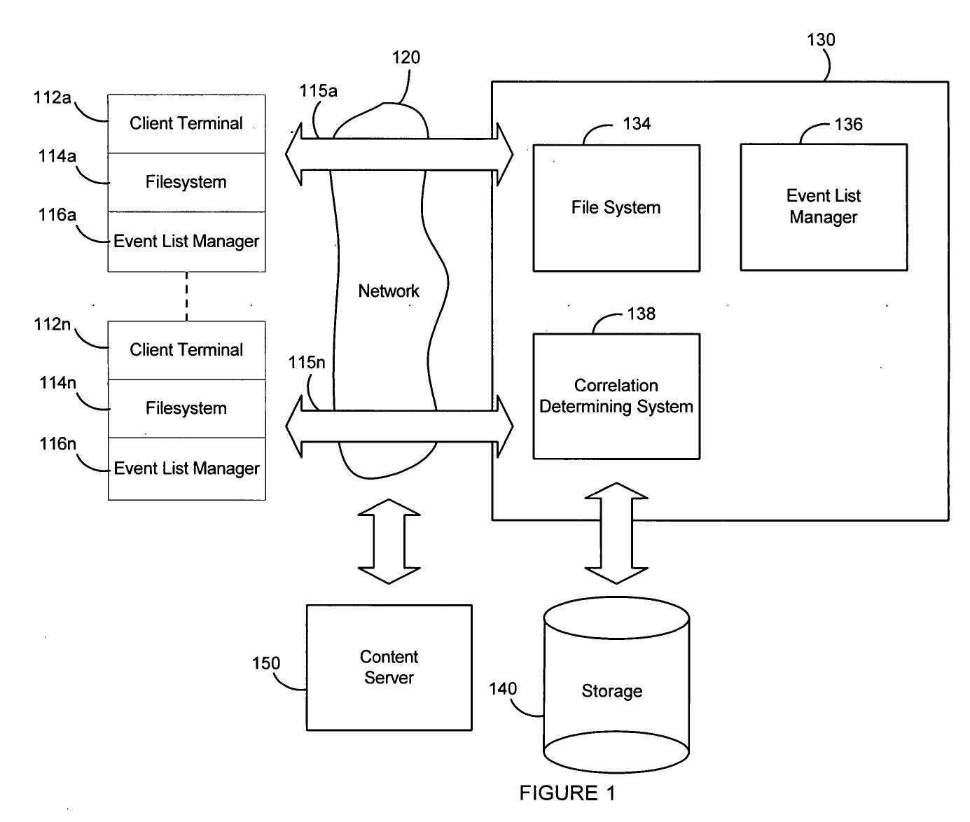

FIG. 1 illustrates an example of the system architecture 100 according to one embodiment of the invention. Client terminals 112a-112n (hereinafter identified collectively as 112) and server(s) 130 may be connected via a wired network, a wireless network, a combination of the foregoing and/or other network(s) (for example the internet) 120. The system of FIG. 1 is provided for illustrative purposes only and should not be considered a limitation of the invention. Other configurations may be used.

The client terminals 112 may include any number of terminal devices including, for example, personal computers, laptops, PDAs, cell phones, Web TV systems, devices that combine the functionality of one or more of the foregoing or other terminal devices, and various other client terminal devices capable of performing the functions specified herein. According to one embodiment of the invention, users may be assigned to one or more client terminals.

According to another embodiment of the invention, communications may be directed between one client terminal 112 and another client terminal 112 via network 120, such as the Internet. Client terminals 112 may communicate via communications media 115a-115n (hereinafter identified collectively as 115), such as, for example, any wired and/or wireless media. Communications between respective client terminals 112 may occur substantially in real-time if the client terminals 112 are operating online.

According to another embodiment of the invention, communications may be directed between client terminals 112 and content server(s) 150 via network 120, such as the Internet. Client terminals 112 may communicate via communications media 115, such as, for example, any wired and/or wireless media. Communications between client terminals 112 and the content server 150 may occur substantially in real-time if the devices are operating online. One of ordinary skill in the art will appreciate that communications may be conducted in various ways and among various devices.

Communications via network 120, such as the Internet, may be implemented using current and future language conventions and/or current and future communications protocols that are generally accepted and used for generating and/or transmitting messages over the network 120. Language conventions may include Hypertext Markup Language (“HTML”), extensible Markup Language (“XML”) and other language conventions. Communications protocols may include, Hypertext Transfer Protocol (“HTTP”), TCP/IP, SSL/TLS, FTP, GOPHER, and/or other protocols.

According to one embodiment of the invention, client terminals 112 are configured to interact with objects, including applications, documents, files, email messages, chat sessions, web sites, address book entries, calendar entries, web browsing history, RSS feeds, audio files, source code, instant message conversations, instant relay chat conversations, or other objects. The objects may include information, such as personal information, user data, and/or other information. The objects may reside on client 112, server 130, storage 140, and/or content server 150. Communications between the client terminals 112 and server 130 may be communicated through a proxy server or other servers. Users may directly or indirectly access several types of objects during the course of the computer session. According to one embodiment of the invention, users may perform actions through a graphical user interface (GUI) or other interface.

According to one embodiment of the invention, user actions may be tracked using triggering events, including user actions performed on objects and/or other triggering events.

According to one embodiment of the invention, information corresponding to objects may be processed in real-time or may be stored for subsequent processing. Storage 140, or other storage device, may be used to store the information, among other data.

According to another embodiment of the invention, client terminal 112 may include a filesystem 114a-114n (hereinafter identified collectively as 114) that manages the objects. Alternatively, the objects may be managed by a filesystem 134 that is located at server 130. Filesystems 114/134 may include directories that associate object names with objects by connecting the object name to an index, called an inode. The object name associated with the gathered information may be indexed to keep track of the physical location of objects that are placed on a medium, the logical location of objects within a database, or other location of objects. According to one embodiment of the invention, a plurality of indexes may be provided, including one index for static properties and one index for mutable data, such as filenames, comments, and other mutable data. This configuration enables efficient updating of the mutable properties. The indexing may be performed in real-time to enable real-time searching of the filesystem. While an exemplary embodiment of the invention is directed to filesystems that organize objects corresponding to user initiated actions and/or computer initiated actions, one of ordinary skill in the art will readily appreciate that the filesystems 114/134 may organize objects associated with any data. Furthermore, it will be readily appreciated that the objects may be organized according to any manner.

According to one embodiment of the invention, as users and/or computers interact with objects via client terminals 112, the interactions generate events. For example, when objects are renamed, the act of renaming the object triggers an event that is communicated to the system. Other common types of event generators include modifications to data or metadata of objects, deletions of objects, saving of objects, and other types of event generators. The inodes within filesystems 114/134 may forward the events to corresponding event list managers 116a-116n (hereinafter identified collectively as 116) that reside on corresponding client terminals 112 and/or to event list manager 136 that resides on server 130. Event list managers 116/136 may manage events as they are generated by inodes within filesystems 114/134 in order to create an accurate, consistent and atomic view of the non-transactional filesystem or a subset thereof.

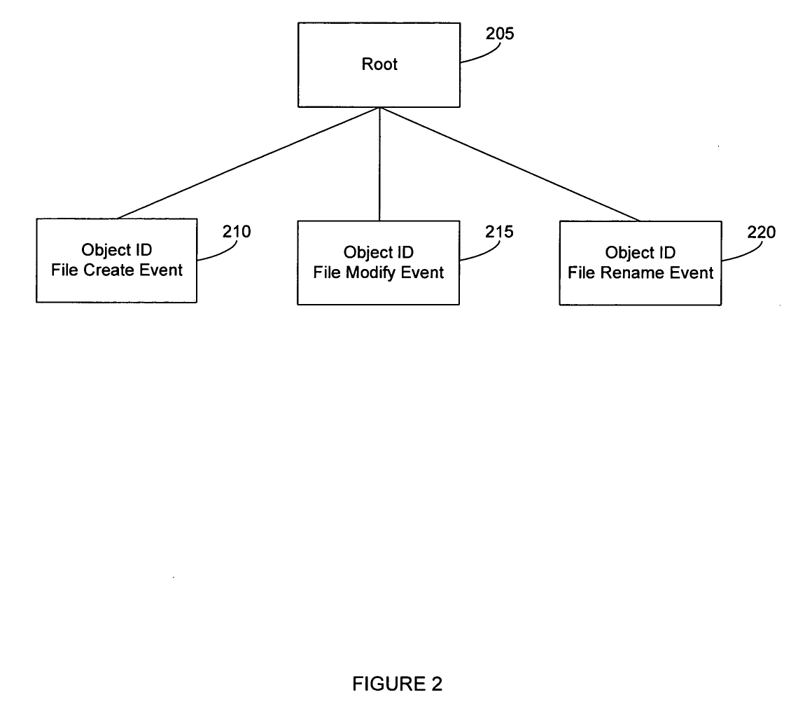

According to one embodiment of the invention, FIG. 2 illustrates a B-tree 200 that may be used to store events. One of ordinary skill in the art will readily appreciate that other data structures may be used to store events. The B-tree is a data structure that is designed to minimize the number of nodes that are traversed in searching for a particular node in the tree. B-trees are known in the art and are not described herein. FIG. 2 illustrates a B-tree with only three nodes and a height of one, but it will be readily appreciated by one of ordinary skill in the art that B-trees can have any number of nodes and any height depth.

According to one embodiment of the invention, nodes in B-tree 200 may be keyed by filesystem ID with all events that are associated with a particular filesystem object being communicated to event list managers 116/136. When an event first touches an object on the filesystem, the ID that is used by the filesystem to identify the object may be used as the key for a new node in B-tree 200. A new node may include information, such as the type of event that occurred. The nodes 210, 215, 220 may communicate information including filesystem ID, event type, object metadata, and other information. To enable the system to track when objects are renamed, for example, a renaming event that includes information identifying the old object name and the new object name may be communicated to the event list managers 116/136. By contrast, in known systems that do not generate a renaming event, the known system is provided with information that the old object name is gone and that the new object name has appeared. Under this situation, however, the known system loses all non-file-derivable metadata whenever objects are renamed.

According to another embodiment of the invention, a user-space algorithm is provided that adds a watch to all objects in the filesystem 114/134 and avoids a race hazard. The user-space algorithm may recursively generate an accurate, consistent, and atomic view of the non-transactional filesystem, or a subset thereof, from a given point in the filesystem 114/134 without explicit filesystem 114/134 or file notification system support for building an atomic view. In other words, a watch addition that is inserted at a point /foo in a directory also may add a watch to all objects that are located below the /foo directory on the filesystem B-tree. The user-space algorithm adds a watch to all objects and directories in the filesystem 114/134 and all events that are generated by the objects may be captured, while avoiding the race hazard associated with inotify. The user-space algorithm avoids race hazards involving new directories by reading the contents of the directories after a watch is added.

According to one embodiment, the invention provides a view of the filesystem in real-time, in user-space, and in memory. The user-space algorithm generates a complete and consistent filesystem view that is updated in real-time. For example, if an object name change occurs while a directory view is being generated, the user-space algorithm ensures that the object name change is detected and that the directory view will be updated in real-time.

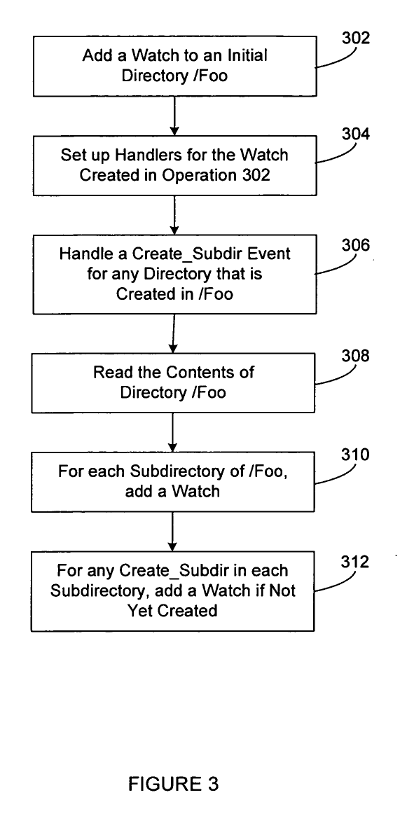

According to another embodiment of the invention illustrated in FIG. 3, a user-space algorithm may be coupled with the known inotify file change notification kernel to create an inotify event that avoids a race hazard. In operation 302, a watch is added to an initial directory, call it /foo. In operation 304, watch handlers are set up for the watch that is created in operation 302. The watch handlers are callbacks that handle events on a specified watch. In operation 306, CREATE_SUBDIR events are handled for any directory that is created in /foo. In operation 308, the contents of directory /foo are read. In operation 310, for each subdirectory of /foo (call it /bar) read in operation 308, add a watch. In operation 312, for any CREATE_SUBDIR event on /bar, add a watch if a watch is not yet created on /bar. Repeat these steps for any subdirectories of /bar, as with /foo, repeating until no more subdirectories exist (i.e., the leaf nodes are reached). The directory traversal may be performed as either depth-first or breadth-first. Typically, performing breadth-first traversal is considered more efficient than depth-first traversal. In general, if an event occurs on a watch that signifies the creation of a new directory, but a watch has not yet been added to the new directory, a watch is added to the new directory, a watch handler is setup, and the subdirectories are read. The user-space algorithm avoids race hazards involving new directories by reading the contents of the directories or subdirectories after the watch is added. Upon completion, a watch will be added to directory /foo and all subdirectories down the tree from /foo. In other words, the particular ordering of the watch setup versus reading of the directories enables any potential race hazards to be handled by the watch handlers.

The foregoing presentation of the described embodiments is provided to enable any person skilled in the art to make or use the invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, as a firmware program loaded into non-volatile storage or a software program loaded from or into a data storage medium as machine-readable code, such code being instructions executable by an array of logic elements such as a microprocessor or other digital signal processing unit, or may include other implementations.

Embodiments of the invention include a computer program containing one or more sequences of machine-readable instructions describing a method as disclosed above, or a data storage medium (e.g. semiconductor memory, magnetic or optical disk) having such a computer program stored therein. The invention is not intended to be limited to the embodiments provided above, but rather is to be accorded the widest scope consistent with the principles and novel features disclosed in any fashion herein. The scope of the invention is to be determined solely by the appended claims.

We claim:

1. A method of generating a file change notification in real-time for a filesystem according to a user-space algorithm, the method comprising:
adding a watch to an initial directory;
establishing handlers for the watch;
reading content of the initial directory after the watch is added;
adding a subdirectory watch to subdirectories of the initial directory;
establishing handlers for the subdirectory watch; and
reading content of the subdirectories after the subdirectory watch is added.

2. The method according to claim 1, further comprising:
detecting creation of a new subdirectory in real-time;
adding a new watch to the new subdirectory;
establishing handlers for the new watch; and
reading content of the new subdirectory after the new watch is added.

4. The method according to claim 1, further comprising:
adding an object watch for objects within the initial directory;
establishing handlers for the objects watches;
reading content of the objects after the object watch is added.

5. The method according to claim 4, further comprising presenting a view of the filesystem in real-time.

6. The method according to claim 4, further comprising storing a representation of the filesystem in a memory.

7. The method according to claim 6, further comprising updating the representation of the filesystem according to events that are generated for the objects, the initial directory and the subdirectories.

8. The method according to claim 4, further comprising detecting an event associated with the objects, the initial directory and the subdirectories.

9. The method according to claim 4, wherein the objects include (i) applications, (ii) documents, (iii) files, (iv) electronic mail messages, (v) chat sessions, (vi) web sites, (vii) address book entries, (viii) calendar entries, (ix) web browsing history, (x) RSS feeds, (xi) audio files, (xii) source code, (xiii) instant messaging conversations, (xiv) instant relay chat conversations, or any combination of (i) to (xiv).

10. A method of generating an atomic view of a non-transactional filesystem, comprising:
accessing a kernel-level file change notification;
accessing a user-space algorithm;
accessing an initial directory that is stored in a memory;
accessing objects that are stored in the memory;
associating object names with the objects through an inode;
adding a directory watch to the initial directory;
adding an object watch to each object;
establishing handlers for the directory watch and the object watch;
reading content of the initial directory and the objects after the directory watch and the object watch are added;
adding a subdirectory watch to subdirectories of the initial directory;
establishing handlers for the subdirectory watch;
reading content of the subdirectories after the subdirectory watch is added; and
generating events that are triggered by interactions with the initial directory, objects, and subdirectories.

11. The method according to claim 10, further comprising presenting a view of the filesystem in real-time.

12. The method according to claim 10, further comprising storing a representation of the filesystem in a memory.

13. The method according to claim 12, further comprising updating the representation of the filesystem in real-time according to the events that are generated by interactions with the initial directory, objects and subdirectories.

14. The method according to claim 10, wherein the objects include (i) applications, (ii) documents, (iii) files, (iv) electronic mail messages, (v) chat sessions, (vi) web sites, (vii) address book entries, (viii) calendar entries, (ix) web browsing history, (x) RSS feeds, (xi) audio files, (xii) source code, (xiii) instant messaging conversations, (xiv) instant relay chat conversations, or any combination of (i) to (xiv).

15. The method according to claim 10, further comprising discovering objects using (i) content-based searching, (ii) context-based searching, (iii) user initiated action-based searching, (iv) computer initiated action-based searching or any combination of (i) to (iv).

16. A device for generating an atomic view of a non-transactional file system, comprising:
a processor that includes instructions for:
accessing a kernel-level file change notification;
accessing a user-space algorithm;
accessing an initial directory that is stored in a memory;
accessing objects that are stored in the memory;
associating object names with the objects through an inode;
adding a directory watch to the initial directory;
adding an object watch to each object;
establishing handlers for the directory watch and the object watch;
reading content of the initial directory and the objects after the directory watch and the object watch are added;
adding a subdirectory watch to subdirectories of the initial directory;
establishing handlers for the subdirectory watch;
reading content of the subdirectories after the subdirectory watch is added; and
generating events that are triggered by interactions with the initial directory, objects, and subdirectories.

17. The device according to claim 16, further comprising a user interface that presents a view of the filesystem in real-time.

18. The device according to claim 16, further comprising a memory that stores a representation of the filesystem.

19. The device according to claim 16, wherein the processor updates the representation of the filesystem in real-time according to the events that are generated by interactions with the initial directory, objects and subdirectories.

20. The device according to claim 16, wherein the objects include (i) applications, (ii) documents, (iii) files, (iv) electronic mail messages, (v) chat sessions, (vi) web sites, (vii) address book entries, (viii) calendar entries, (ix) web browsing history, (x) RSS feeds, (xi) audio files, (xii) source code, (xiii) instant messaging conversations, (xiv) instant relay chat conversations, or any combination of (i) to (xiv).
